(19) United States
(12) Patent Application Publication
(10) Pub. No.: US 2026/0351495 A1
(43) Pub. Date: Nov. 5, 2026

(54) SCROLL WHEEL ASSEMBLY WITH SPRING

(71) Applicant: Microsoft Technology Licensing, LLC, Redmond, WA (US)

(72) Inventors: Max Robert RICHTER, Auburn, WA (US); Benjamin Uriel Sherrett TEMPLE, Redmond, OR (US); Christopher Erol OGUT, Vancouver, WA (US); Daniel Calvert CANFIELD, McMinnville, OR (US); Kent Allen CAMPBELL, Issaquah, WA (US); Isadora Helena PEREIRA COSTA, Seattle, WA (US)

(73) Assignee: Microsoft Technology Licensing, LLC, Redmond, WA (US)

(21) Appl. No.: 19/199,296

(22) Filed: May 5, 2025

(51) Int. Cl. H01H 19/00; A63F 13/24; H01H 19/04; H01H 19/14

(52) U.S. Cl. CPC H01H 19/001; A63F 13/24; H01H 19/04; H01H 19/14

(57) ABSTRACT

A scroll wheel assembly for an input device comprises a housing including a face plate that defines an aperture. A scroll wheel protrudes from the aperture and a shaft couples the scroll wheel to a rotary encoder. The shaft comprises an inner bearing portion located on an inner end of the scroll wheel and an outer bearing portion located on an outer end of the scroll wheel. A spring biases the inner bearing portion and the outer bearing portion toward the face plate.

### BACKGROUND

Input devices can utilize one or more scroll wheels to receive user input. In some devices, space constraints can limit the functionality and available locations for scroll wheels.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

In some examples, a scroll wheel assembly for an input device comprises a housing comprising a face plate that defines an aperture. A scroll wheel protrudes from the aperture and a shaft couples the scroll wheel to a rotary encoder. The shaft comprises an inner bearing portion located on an inner end of the scroll wheel and an outer bearing portion located on an outer end of the scroll wheel. A spring assembly biases the inner bearing portion and the outer bearing portion toward the face plate.

In some examples an input device comprises a scroll wheel assembly, with the scroll wheel assembly comprising a housing comprising a face plate that defines an aperture. A scroll wheel protrudes from the aperture and a shaft couples the scroll wheel to a rotary encoder. The shaft comprises an inner bearing portion located on an inner end of the scroll wheel and an outer bearing portion located on an outer end of the scroll wheel. A spring assembly biases the inner bearing portion and the outer bearing portion toward the face plate.

In some examples, an input device comprises a housing comprising a face plate that defines a left aperture and a right aperture. A left scroll wheel assembly includes a left scroll wheel that protrudes from the left aperture and a left shaft that couples the left scroll wheel to a left rotary encoder. The left shaft comprises a left inner bearing portion located on an inner end of the left scroll wheel and a left outer bearing portion located on an outer end of the left scroll wheel. A left spring biases the left inner bearing portion and the left outer bearing portion toward the face plate.

The input device also includes a right scroll wheel assembly comprising a right scroll wheel protruding from the right aperture and a right shaft coupling the right scroll wheel to a right rotary encoder. The right shaft comprises a right inner bearing portion located on an inner end of the right scroll wheel and a right outer bearing portion located on an outer end of the right scroll wheel. A right spring biases the right inner bearing portion and the right outer bearing portion toward the face plate.

### BRIEF DESCRIPTION OF THE DRAWINGS

FIG. 1 depicts an example input device in the form of a game controller that includes scroll wheel assemblies according to examples of the present disclosure.

FIG. 2 is a front perspective view of the scroll wheel assemblies of the game controller of FIG. 1 according to examples of the present disclosure.

FIG. 3 shows a partially exploded front perspective view of the scroll wheel assemblies of FIG. 2 according to examples of the present disclosure.

FIG. 4 is rear perspective view of the scroll wheel assemblies of FIG. 2 according to examples of the present disclosure.

FIG. 5 shows a partially exploded front perspective view of a portion of the scroll wheel assemblies of FIG. 3 according to examples of the present disclosure.

FIG. 6 is an enlarged top view of the left scroll wheel assembly of FIG. 2 according to examples of the present disclosure.

FIG. 7 is a rear view of the left and right scroll wheels and left and right springs of the scroll wheel assemblies of FIG. 2.

FIG. 8 is a bottom perspective view of scroll wheel assemblies for a game controller according to the present invention.

FIG. 9 is a front view of the scroll wheel assemblies of FIG. 8.

FIG. 10 is a right view of the scroll wheel assemblies of FIG. 8.

FIG. 11 is a left view of the scroll wheel assemblies of FIG. 8.

FIG. 12 is a bottom view of the scroll wheel assemblies of FIG. 8 with an encircled portion indicating the enlarged area of FIG. 13.

FIG. 13 is an enlarged view of the encircled portion of the scroll wheel assemblies for a game controller labeled 13 in FIG. 12.

FIG. 14 is the enlarged view of the encircled portion of the scroll wheel assemblies for a game controller labeled 13 in FIG. 12 shown with disclaimed regions.

FIG. 15 is a top view of the scroll wheel assemblies of FIG. 8.

FIG. 16 is a rear view of the scroll wheel assemblies of FIG. 8.

The even-length broken lines in FIGS. 8-16 are directed to environment and form no part of the claimed design. The dash-dot-dash broken lines in FIGS. 12-14 encircling portions of the scroll wheel assemblies illustrated in enlargements form no part of the claimed design.

### DETAILED DESCRIPTION

Electronic devices such as various input devices can utilize one or more scroll wheels to receive user input. In some devices, space constraints, chassis configurations, other components, and/or design considerations can limit available locations and/or functionality for scroll wheels. In these examples, a scroll wheel may not be implemented, may be positioned in a less desirable location in the device, and/or may be implemented with limited functionality. Additionally, integrating additional components near the scroll wheel can prove challenging.

Accordingly, and to address one or more of these shortcomings, the present disclosure describes scroll wheel assemblies and input devices comprising scroll wheel assemblies that include a housing comprising a face plate that defines an aperture with a scroll wheel protruding from the aperture. A shaft couples the scroll wheel to a rotary encoder, with the shaft comprising an inner bearing portion located on an inner end of the scroll wheel and an outer bearing portion located on an outer end of the scroll wheel. A spring biases the inner bearing portion and the outer bearing portion toward the face plate. Advantageously and as described further below, by utilizing the disclosed spring and housing configurations and related components to bias the inner and outer bearing portions of the shaft toward the face plate, scroll wheel assemblies of the present disclosure embody a compact design that can be positioned in space-constrained locations that may not otherwise accommodate a rotary encoder or other components, thereby expanding potential device design and configuration opportunities. Additionally and in some examples, the disclosed configurations enable the scroll wheel to provide rotational freedom for rotary input while also enabling translational movement for actuation of an adjacent switch.

In some examples and as described further below, the housing of an input device comprises a face plate that defines a left aperture and a right aperture. A left scroll wheel assembly comprises a left scroll wheel that protrudes from the left aperture. A left shaft couples the left scroll wheel to a left rotary encoder, with the left shaft comprising a left inner bearing portion located on an inner end of the left scroll wheel and a left outer bearing portion located on an outer end of the left scroll wheel. A left spring biases the left inner bearing portion and the left outer bearing portion toward the face plate.

The input device also includes a right scroll wheel assembly comprising a right scroll wheel that protrudes from the right aperture. A right shaft couples the right scroll wheel to a right rotary encoder, with the right shaft comprising a right inner bearing portion located on an inner end of the right scroll wheel and a right outer bearing portion located on an outer end of the right scroll wheel. A right spring biases the right inner bearing portion and the right outer bearing portion toward the face plate With these configurations, and in another potential advantage of the present disclosure described further below, two scroll wheels can each utilize a spring to bias the inner and outer bearing portions of their corresponding shaft toward the face plate, thereby enabling both scroll wheel assemblies to be positioned in space-constrained locations that also enable one or more additional components to be located between the left scroll wheel and the right scroll wheel.

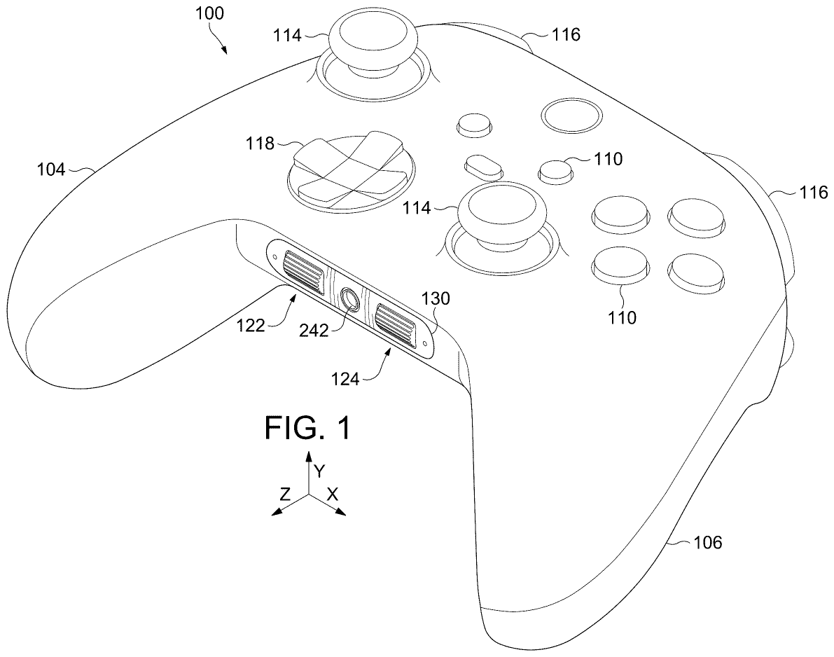

FIG. 1 depicts an example input device in the form of game controller 100. Game controller 100 includes a left handle 104 and right handle 106 configured to be held by a user's left hand and right hand, respectively. In the present example game controller 100 comprises a plurality of input components including buttons 110, thumbsticks 114, bumpers 116, and a direction pad 118. As described in more detail below, and in one potential advantage of the present disclosure, in this example game controller 100 also includes a left scroll wheel assembly 122 and a right scroll wheel assembly 124 that share a common housing. As described in more detail below, in this example left scroll wheel assembly 122 and right scroll wheel assembly 124 utilize the same components and are functionally equivalent in structure.

In other examples, input devices of the present disclosure such as game controller 100 can utilize a single scroll wheel assembly and/or different combinations of other input components. In other examples, scroll wheel assemblies of the present disclosure can be utilized with a wide variety of other types and form factors of input devices, including but not limited to keyboards, mice, gamepads, joysticks, steering wheels, wearable electronic devices, and laptop devices. For example, portable computing devices having thin form factors can benefit from utilizing embodiments of scroll wheel assemblies described herein.

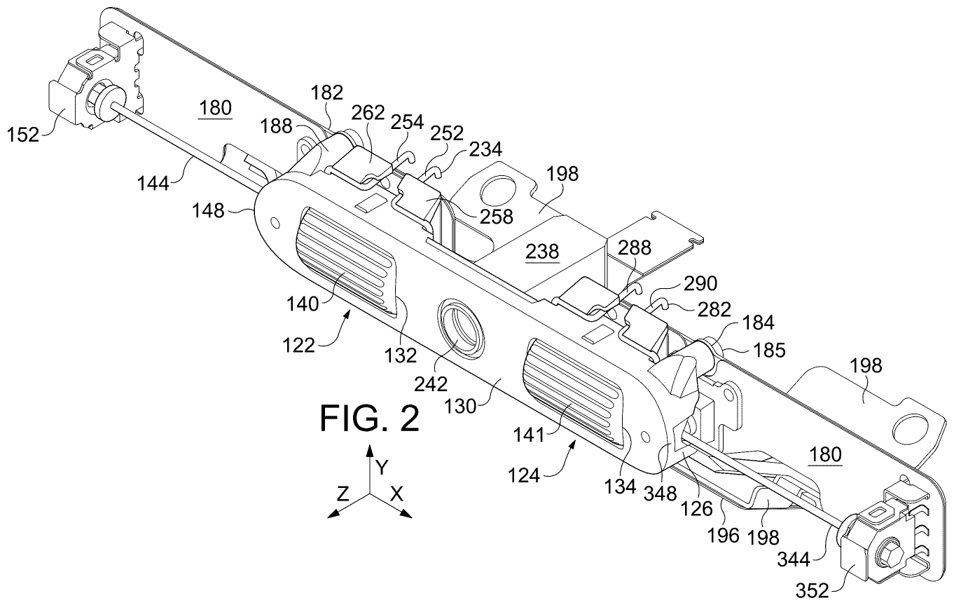

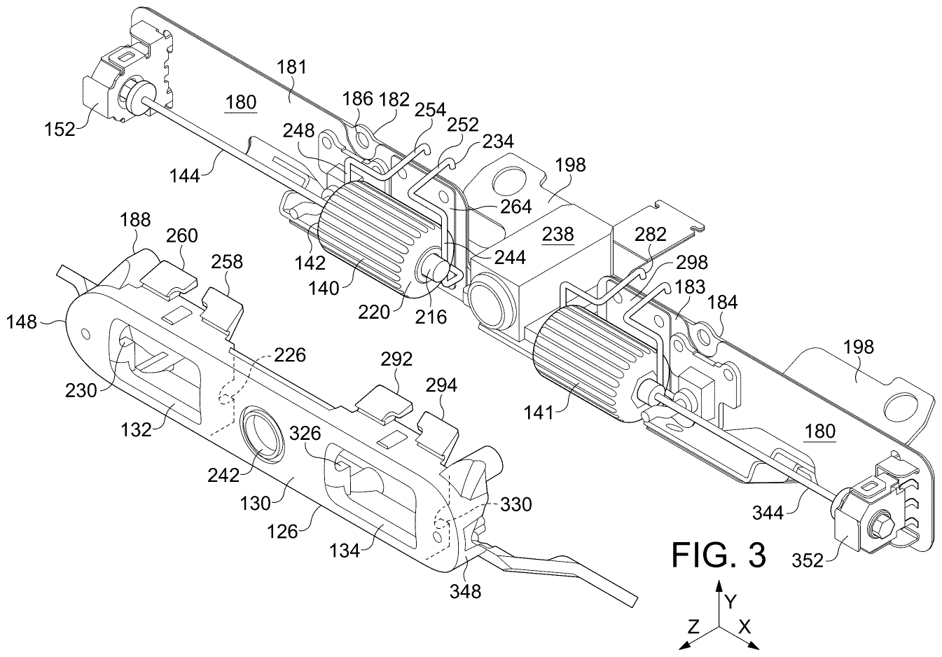

A description of left scroll wheel assembly 122 will now be provided. For purposes of the present disclosure, the components, features, and structures of left scroll wheel assembly 122 and their interrelationships and operation as described herein apply equally to the right scroll wheel assembly 124. In one example and with reference now to FIGS. 2 and 3, left scroll wheel assembly 122 includes a housing 126 comprising a face plate 130 that defines a left aperture 132 and a right aperture 134. A left scroll wheel 140 protrudes from the left aperture 132 and is coupled to a left shaft 144. Left shaft 144 extends from a left end 148 of the housing 126. A left rotary encoder 152 is laterally spaced from the left end 148 of housing 126 and is coupled to left shaft 144. In different examples left rotary encoder 152 can take the form of an optical encoder, magnetic encoder, or other suitable electromechanical device that converts the angular position of left shaft 144 to analog or digital output signals.

In other examples of input devices and scroll wheel assemblies of the present disclosure, housing 126 comprises a single aperture from which a single scroll wheel protrudes.

In the present example left scroll wheel assembly 122 and right scroll wheel assembly 124 each utilize a flexible printed circuit 180 to which components of the assemblies are mounted. With reference to FIG. 3, an upper left portion 181 of flexible printed circuit 180 is affixed to a left stiffener plate 182, and an upper right portion 183 is affixed to a right stiffener plate 184.

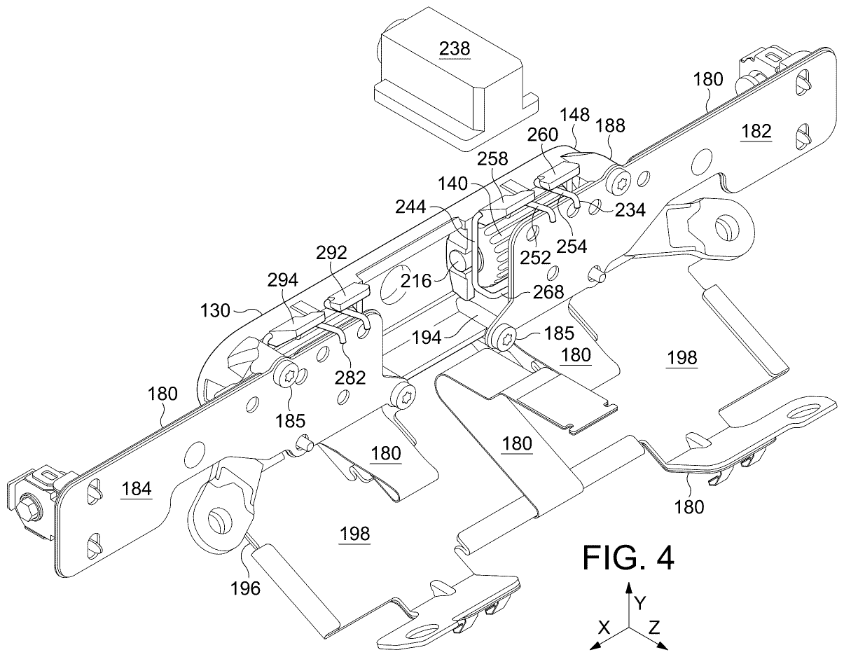

As described further below, housing 126 is mounted to left stiffener plate 182 and right stiffener plate 184 to provide a stable base in which left scroll wheel 140 and right scroll wheel 141 can be rotatably mounted. In this example and with reference to FIGS. 2 and 3, a bolt 185 extends through an upper aperture 186 in left stiffener plate 182 and into an upper receiving post 188 extending from housing 126 to removably affix housing to the stiffener plate. Additionally and with reference also to FIG. 4, another bolt 185 extends through a lower aperture in left stiffener plate 182 and into a lower receiving post 194 extending from housing 126 to removably affix the housing to the stiffener plate. Housing 126 is mounted to right stiffener plate 184 in a similar manner.

With reference to FIGS. 3-5 , in the present example left shaft 144 comprises a left inner bearing portion 216 that protrudes from the inner end 220 of the left scroll wheel 140 and a left outer bearing portion 222 that protrudes from the outer end 142 of the left scroll wheel. Left inner bearing portion 216 is rotatably received in a left inner notch 226 defined in housing 126, and left outer bearing portion 222 is rotatably received in a left outer notch 230 defined in the housing. In one potential advantage of the present disclosure and as described further below, a left spring 234 is biased against the left inner bearing portion 216 and left outer bearing portion 222 to retain these portions against the left inner notch 226 and left outer notch 230 while also enabling rotation of these portions and attached left scroll wheel 140.

More particularly and as shown in FIGS. 3-5 , left spring 234 comprises a left inner biasing arm 244 contacting the left inner bearing portion 216 and a left outer biasing arm 248 contacting the left outer bearing portion 222 of left shaft 144. Advantageously, in this configuration left inner biasing arm 244 and left outer biasing arm 248 of left spring 234 simultaneously engage left inner bearing portion 216 and left outer bearing portion 222, respectively, of left shaft 144 to provide substantially uniform biasing of these bearing portions toward the face plate 130 and into their corresponding left inner notch 226 and left outer notch 230 defined in housing 126. In this manner, left inner biasing arm 244 and left outer biasing arm 248 of left spring 234 operate to resiliently maintain left scroll wheel 140 in a nominal position in which left inner bearing portion 216 and left outer bearing portion 222 of left shaft 144 are biased against left inner notch 226 and left outer notch 230, while also enabling free rotation of these portions and attached left scroll wheel 140.

In another potential advantage of the present configuration, to generate the biasing forces applied by left inner biasing arm 244 and left outer biasing arm 248, left spring 234 comprises a left inner preload arm 252 and a left outer preload arm 254. As shown in FIG. 2, in the present example left inner preload arm 252 is biased against and retained by a left inner preload surface 258 of the housing 126, and left outer preload arm 254 is biased against and retained by a left outer preload surface 262 of the housing.

Advantageously and with reference to FIG. 3, when housing 126 is installed and affixed to the left stiffener plate 182 and right stiffener plate 184, left inner preload surface 258 contacts and biases left inner preload arm 252 in the negative Y-axis direction, which correspondingly biases left inner biasing arm 244 in the positive Z-axis direction to urge left inner bearing portion 216 against the left inner notch 226 of housing 126. Similarly, when housing 126 is installed and affixed to the left stiffener plate 182 and right stiffener plate 184, left outer preload surface 262 contacts and biases left outer preload arm 254 in the negative Y-axis direction, which correspondingly biases left outer biasing arm 248 in the positive Z-axis direction to urge left outer bearing portion 222 against the left outer notch 230 of housing 126.

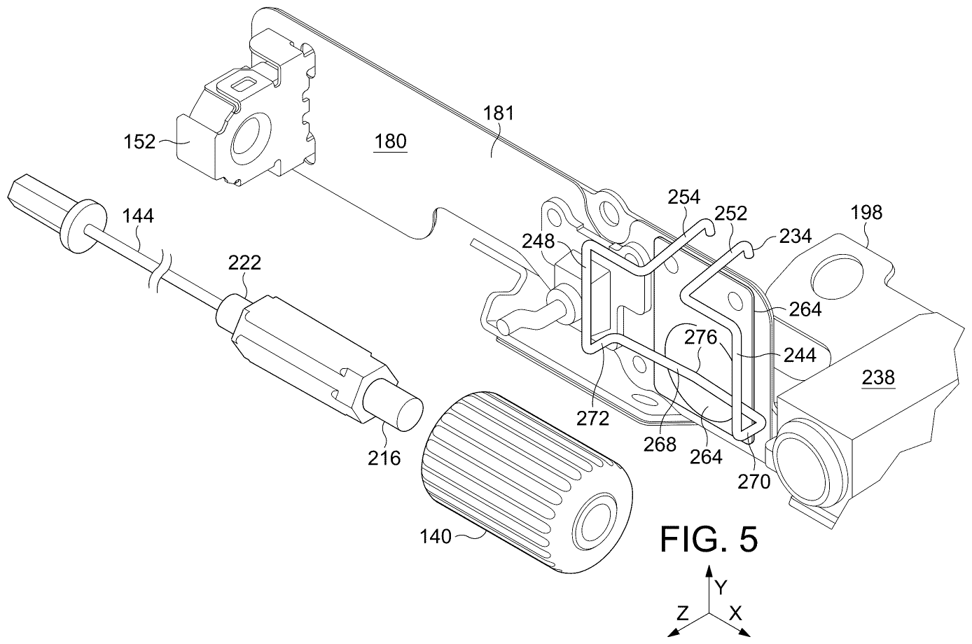

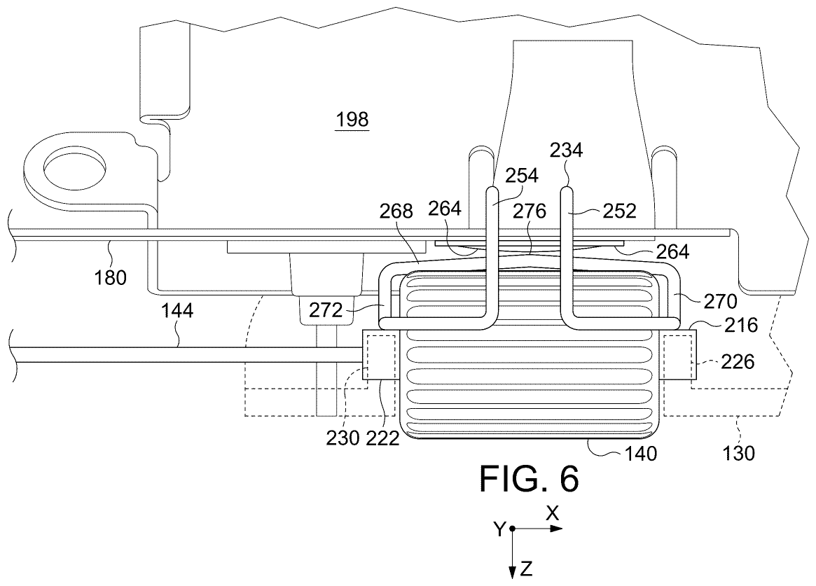

With reference now to FIGS. 5 and 6, and in another potential advantage of the present disclosure, a left dome switch 264 is mounted to a proximal end of the upper left portion 181 of flexible printed circuit 180 at a location adjacent to the left scroll wheel 140. As described in more detail below, left spring 234 is configured to provide a measure of compliance in the negative Z-axis direction, thereby enabling a user to actuate the left dome switch 264 by depressing left scroll wheel 140 in the negative Z-axis direction.

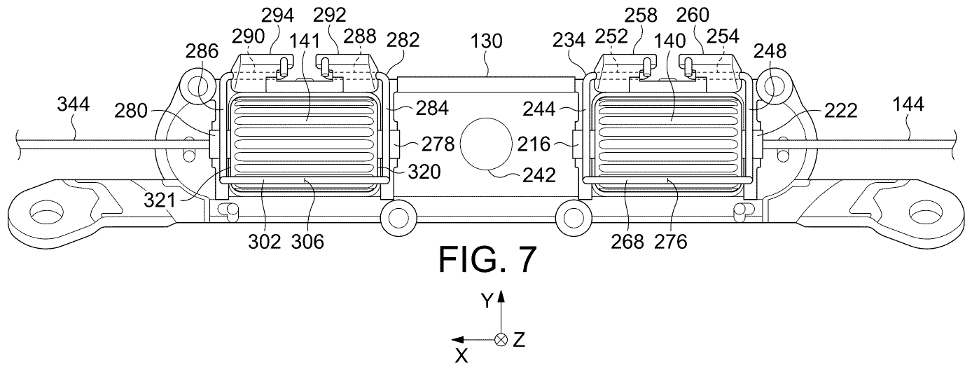

More particularly and with reference to FIGS. 6 and 7, in the present example left spring 234 comprises a transverse arm 268 extending between the left inner biasing arm 244 and the left outer biasing arm 248. In the present example, transverse arm 268 is connected to left inner biasing arm 244 and left outer biasing arm 248 via left inner connector portion 270 and left outer connector portion 272, respectively. Advantageously and in this manner, transverse arm 268 is spaced in the negative Z-axis direction from the left inner biasing arm 244 and left outer biasing arm 248 to provide space for left scroll wheel 140 to freely rotate.

Additionally, and in another potential advantage as shown in FIG. 6, transverse arm 268 comprises a trigger feature in the form of a protruding midpoint 276 located between the left inner biasing arm 244 and outer biasing arm 248. In this manner, the protruding midpoint 276 of transverse arm 268 is configured to actuate dome switch 264 when the left scroll wheel 140 is translated away from the face plate 130 in the negative Z-axis direction.

In the present example and as shown in FIG. 6, the protruding midpoint 276 is slightly spaced from left dome switch 264 when the left scroll wheel 140 is located in a nominal (non-depressed) position as shown. As described above, left inner biasing arm 244 and left outer biasing arm 248 of left spring 234 contact and bias left inner bearing portion 216 and left outer bearing portion 222, respectively, of left shaft 144 in the positive Z-axis direction. In this manner, and in another potential advantage of the present disclosure, left inner biasing arm 244 and left outer biasing arm 248 of left spring 234 provide a measure of resistance to translation of the left scroll wheel 140 and protruding midpoint 276 of transverse arm 268 in the negative Z-axis direction, and also provide a return force that translates the left scroll wheel in the positive Z-axis direction back into its nominal position when a user ceases to apply force on the left scroll wheel in the negative Z-axis direction.

In another potential advantage of the present disclosure, left spring 234 is a wire form spring. Advantageously, utilizing the above-described configuration of a wire form spring provides an inexpensive component that performs multiple functionalities as described above. Additionally, the wire form spring configuration is easily and conveniently installed and removed from the left inner preload surface 258 and left outer preload surface 262.

In another potential advantage of the present disclosure, these components associated with rotatably retaining left scroll wheel 140 within housing 126 and enabling translation of the scroll wheel relative to the housing for actuation of left switch 264 are easily decoupled from the left scroll wheel, thereby further enabling a simple disassembly and replacement the scroll wheel.

In another potential advantage of the present configuration, utilizing the above-described configurations of left spring 234, left scroll wheel 140, and housing 126 allows these components to occupy a compact footprint within the housing, thereby enabling other uses of space within the housing. Accordingly and in some examples, the configurations of housing 126, left scroll wheel assembly 122, and right scroll wheel assembly 124 advantageously provide space within the housing to locate an electromechanical component at least partially between left scroll wheel 140 and right scroll wheel 141.

In the present example and with reference to FIGS. 2, 3, and 7, an electromechanical component 238 in the form of an audio component is located at least partially between the left scroll wheel 140 and the right scroll wheel 141. Additionally, housing 126 comprises a central aperture 242 between the left aperture 132 and the right aperture 134, with the central aperture configured to removably receive a connector, such as an audio jack, that engages with the electromechanical component 238. In other examples, a variety of different electromechanical components or other configurations of components can be located between the left scroll wheel 140 and the right scroll wheel 141.

As noted above, and in one potential advantage of the present disclosure, left scroll wheel assembly 122 and right scroll wheel assembly 124 share a common housing 126. Advantageously and as described in more detail below, the configurations of housing 126, left scroll wheel assembly 122, and right scroll wheel assembly 124 enable the two scroll wheel assemblies to be positioned in game controller 100 for easy and convenient access by a user's left and right thumbs, respectively, while also creating space within the housing for an electromechanical component located at least partially between left scroll wheel and right scroll wheel. Additionally, the above-described components, features, and structures of left scroll wheel assembly 122 and their interrelationships and operation apply equally to the right scroll wheel assembly 124. Accordingly, a simplified description of the components, features, and structures of right scroll wheel assembly 124 will now be provided.

With reference to FIGS. 2 and 3, right scroll wheel 141 protrudes from the right aperture 134 and is coupled to a right shaft 344 extending from a right end 348 of the housing 126. A right rotary encoder 352 is laterally spaced from the right end 348 of housing 126 and is coupled to right shaft 344. As noted above, right scroll wheel assembly 124 also utilizes the flexible printed circuit 180 to which components of the assembly are mounted. Right rotary encoder 352 is mounted to a distal end of the upper right portion 183 of flexible printed circuit 180.

As described above with respect to left scroll wheel 140, components associated with positioning and retaining right scroll wheel 141 for rotational and translational movement within housing 126 are easily decoupled from the right scroll wheel, thereby further enabling easy replacement and customization of different scroll wheels. With reference to FIG. 7 and like left shaft 144 described above, right shaft 344 comprises a right inner bearing portion 278 that protrudes from the inner end 320 of the right scroll wheel 141 and a right outer bearing portion 280 that protrudes from the outer end 321 of the right scroll wheel. With reference also to FIG. 3, right inner bearing portion 278 is rotatably received in a right inner notch 326 defined in housing 126, and right outer bearing portion 280 is rotatably received in a right outer notch 330 defined in the housing. As with left shaft 144 and left spring 234, right spring 282 is biased against the right inner bearing portion 278 and right outer bearing portion 280 of right shaft 344 to retain these portions against the right inner notch 326 and right outer notch 330 while also enabling rotation of these portions and attached left scroll wheel.

More particularly, with reference to FIG. 7 and like left spring 234, the right spring 282 comprises a right inner biasing arm 284 contacting the right inner bearing portion 278 and a right outer biasing arm 286 contacting the right outer bearing portion 280 of right shaft 344. Advantageously and like left spring 234, in this configuration right inner biasing arm 284 and right outer biasing arm 286 of right spring 282 simultaneously engage right inner bearing portion 278 and right outer bearing portion 280, respectively, of right shaft 344 to provide substantially uniform biasing of these bearing portions toward the face plate 130 and into their corresponding right inner notch 326 and right outer notch 330 defined in housing 126. In this manner, right inner biasing arm 284 and right outer biasing arm 286 of right spring 282 operate to resiliently maintain right scroll wheel 141 in a nominal position in which right inner bearing portion 278 and right outer bearing portion 280 of right shaft 344 are biased against right inner notch 326 and right outer notch 330, while also enabling free rotation of these portions and attached right scroll wheel 141.

Also like left spring 234, to generate the biasing forces applied by the right inner biasing arm 284 and right outer biasing arm 286, right spring 282 comprises a right inner preload arm 288 and a right outer preload arm 290. As shown in FIG. 7, in the present example right inner preload arm 288 is biased against and retained by a right inner preload surface 292 of the housing 126, and right outer preload arm 290 is biased against and retained by a right outer preload surface 294 of the housing. When housing 126 is installed and affixed to the left stiffener plate 182 and right stiffener plate 184, right inner preload surface 292 contacts and biases right inner preload arm 288 in the negative Y-axis direction, which correspondingly biases right inner biasing arm 284 in the positive Z-axis direction to urge right inner bearing portion 278 against the right inner notch 326 of housing 126.

Similarly, when housing 126 is installed and affixed to the left stiffener plate 182 and right stiffener plate 184, right outer preload surface 294 contacts and biases right outer preload arm 290 in the negative Y-axis direction, which correspondingly biases right outer biasing arm 286 in the positive Z-axis direction to urge right outer bearing portion 280 against the right outer notch 330 of housing 126.

With reference to FIG. 3, a right dome switch 298 is mounted to a proximal end of the upper right portion 183 of flexible printed circuit 180 at a location adjacent to the right scroll wheel 141. As shown in FIG. 7, right spring 282 comprises a transverse arm 302 extending between the right inner biasing arm 284 and the right outer biasing arm 286. As with left spring 234, transverse arm 302 of right spring 282 is spaced in the negative Z-axis direction from the right inner biasing arm 284 and right outer biasing arm 286, and comprises a trigger feature in the form of a protruding midpoint 306 located between the right inner biasing arm 284 and right outer biasing arm 286. In this manner, the protruding midpoint 306 of transverse arm 302 is configured to actuate right dome switch 298 when the right scroll wheel 141 is translated away from the face plate 130 in the negative Z-axis direction.

As described above for left spring 234, right inner biasing arm 284 and right outer biasing arm 286 of right spring 282 contact and bias right inner bearing portion 278 and right outer bearing portion 280, respectively, of right shaft 344 in the positive Z-axis direction. In this manner, and in another potential advantage of the present disclosure, right inner biasing arm 284 and right outer biasing arm 286 of right spring 282 provide a measure of resistance to translation of the right scroll wheel 141 and protruding midpoint 306 of transverse arm 302 in the negative Z-axis direction, and provide a return force that translates the right scroll wheel 141 in the positive Z-axis direction back into its nominal position when a user ceases to apply force on the right scroll wheel in the negative Z-axis direction.

In the present example and like left spring 234, right spring 282 is a wire form spring that performs multiple functionalities as described above. Additionally, the wire form spring design is conveniently installed and removed from the right inner preload surface 292 and right outer preload surface 294.

The following paragraphs provide additional support for the claims of the application. In one aspect a scroll wheel assembly for an input device comprises comprising a housing comprising a face plate that defines an aperture; a scroll wheel protruding from the aperture; a rotary encoder; a shaft coupling the scroll wheel to the rotary encoder, the shaft comprising an inner bearing portion located on an inner end of the scroll wheel and an outer bearing portion located on an outer end of the scroll wheel; and a spring biasing the inner bearing portion and the outer bearing portion toward the face plate. The scroll wheel assembly may additionally or alternatively include, wherein the housing comprises: an inner notch that receives the inner bearing portion for rotation; and an outer notch that receives the outer bearing portion for rotation. The scroll wheel assembly may additionally or alternatively include, wherein the spring biases the inner bearing portion against the inner notch and biases the outer bearing portion against the outer notch. The scroll wheel assembly may additionally or alternatively include, wherein the spring comprises: an inner biasing arm contacting the inner bearing portion; and an outer biasing arm contacting the outer bearing portion. The scroll wheel assembly may additionally or alternatively include, wherein the spring comprises: an inner preload arm biased against an inner preload surface of the housing; and an outer preload arm biased against an outer preload surface of the housing, wherein the inner preload arm biases the inner biasing arm against the inner bearing portion, and the outer preload arm biases the outer biasing arm against the outer bearing portion. The scroll wheel assembly may additionally or alternatively include, wherein the spring comprises a transverse arm extending between the inner biasing arm and the outer biasing arm. The scroll wheel assembly may additionally or alternatively include, wherein the transverse arm comprises a trigger feature configured to depress a switch when the scroll wheel is translated away from the face plate. The scroll wheel assembly may additionally or alternatively include, wherein the spring is a wire form.

Another aspect provides an input device comprising a scroll wheel assembly, the scroll wheel assembly comprising: a housing comprising a face plate that defines an aperture; a scroll wheel protruding from the aperture; a rotary encoder; a shaft coupling the scroll wheel to the rotary encoder, the shaft comprising an inner bearing portion located on an inner end of the scroll wheel and an outer bearing portion located on an outer end of the scroll wheel; and a spring biasing the inner bearing portion and the outer bearing portion toward the face plate. The input device may additionally or alternatively include, wherein the housing comprises: an inner notch that receives the inner bearing portion for rotation; and an outer notch that receives the outer bearing portion for rotation. The input device may additionally or alternatively include, wherein the spring biases the inner bearing portion against the inner notch and biases the outer bearing portion against the outer notch. The input device may additionally or alternatively include, wherein the spring comprises: an inner biasing arm contacting the inner bearing portion; and an outer biasing arm contacting the outer bearing portion. The input device may additionally or alternatively include, wherein the spring comprises: an inner preload arm biased against an inner preload surface of the housing; and an outer preload arm biased against an outer preload surface of the housing, wherein the inner preload arm biases the inner biasing arm against the inner bearing portion, and the outer preload arm biases the outer biasing arm against the outer bearing portion. The input device may additionally or alternatively include, wherein the spring comprises a transverse arm extending between the inner biasing arm and the outer biasing arm. The input device may additionally or alternatively include, wherein the transverse arm comprises a trigger feature configured to depress a switch when the scroll wheel is translated away from the face plate. The input device may additionally or alternatively include, wherein the spring is a wire form.

Another aspect provides an input device comprising: a housing comprising a face plate that defines a left aperture and a right aperture; a left scroll wheel assembly comprising: a left scroll wheel protruding from the left aperture; a left rotary encoder; a left shaft coupling the left scroll wheel to the left rotary encoder, the left shaft comprising a left inner bearing portion located on an inner end of the left scroll wheel and a left outer bearing portion located on an outer end of the left scroll wheel; and a left spring biasing the left inner bearing portion and the left outer bearing portion toward the face plate; and a right scroll wheel assembly comprising: a right scroll wheel protruding from the right aperture; a right rotary encoder; a right shaft coupling the right scroll wheel to the right rotary encoder, the right shaft comprising a right inner bearing portion located on an inner end of the right scroll wheel and a right outer bearing portion located on an outer end of the right scroll wheel; and a right spring biasing the right inner bearing portion and the right outer bearing portion toward the face plate. The input device may additionally or alternatively include, wherein the left spring biases the left inner bearing portion against a left inner notch of the housing and biases the left outer bearing portion against a left outer notch of the housing, and the right spring biases the right inner bearing portion against a right inner notch of the housing and biases the right outer bearing portion against a right outer notch of the housing. The input device may additionally or alternatively include, wherein the left spring comprises a left inner biasing arm contacting the left inner bearing portion of the left shaft, and a left outer biasing arm contacting the left outer bearing portion of the left shaft; and the right spring comprises a right inner biasing arm contacting the right inner bearing portion of the right shaft and a right outer biasing arm contacting the right outer bearing portion of the right shaft. The input device may additionally or alternatively include, wherein the left spring comprises a left transverse arm extending between the left inner biasing arm and the left outer biasing arm, and the right spring comprises a right transverse arm extending between the right inner biasing arm and the right outer biasing arm.

It will be understood that the configurations and/or approaches described herein are exemplary in nature, and that these specific embodiments or examples are not to be considered in a limiting sense, because numerous variations are possible.

The subject matter of the present disclosure includes all novel and non-obvious combinations and sub-combinations of the various processes, systems and configurations, and other features, functions, acts, and/or properties disclosed herein, as well as any and all equivalents thereof.

The claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure. As used herein, the phrase “and/or” means any or all of multiple stated possibilities.

1. A scroll wheel assembly for an input device, the scroll wheel assembly comprising:
a housing comprising a face plate that defines an aperture;
a scroll wheel protruding from the aperture;
a rotary encoder;
a shaft coupling the scroll wheel to the rotary encoder, the shaft comprising an inner bearing portion located on an inner end of the scroll wheel and an outer bearing portion located on an outer end of the scroll wheel; and
a spring biasing the inner bearing portion and the outer bearing portion toward the face plate.

2. The scroll wheel assembly of claim 1, wherein the housing comprises:
an inner notch that receives the inner bearing portion for rotation; and
an outer notch that receives the outer bearing portion for rotation.

3. The scroll wheel assembly of claim 2, wherein the spring biases the inner bearing portion against the inner notch and biases the outer bearing portion against the outer notch.

4. The scroll wheel assembly of claim 1, wherein the spring comprises:
an inner biasing arm contacting the inner bearing portion; and
an outer biasing arm contacting the outer bearing portion.

5. The scroll wheel assembly of claim 4, wherein the spring comprises:
an inner preload arm biased against an inner preload surface of the housing; and
an outer preload arm biased against an outer preload surface of the housing, wherein the inner preload arm biases the inner biasing arm against the inner bearing portion, and the outer preload arm biases the outer biasing arm against the outer bearing portion.

6. The scroll wheel assembly of claim 4, wherein the spring comprises a transverse arm extending between the inner biasing arm and the outer biasing arm.

7. The scroll wheel assembly of claim 6, wherein the transverse arm comprises a trigger feature configured to depress a switch when the scroll wheel is translated away from the face plate.

8. The scroll wheel assembly of claim 1, wherein the spring is a wire form.

9. An input device comprising a scroll wheel assembly, the scroll wheel assembly comprising:
a housing comprising a face plate that defines an aperture;
a scroll wheel protruding from the aperture;
a rotary encoder;
a shaft coupling the scroll wheel to the rotary encoder, the shaft comprising an inner bearing portion located on an inner end of the scroll wheel and an outer bearing portion located on an outer end of the scroll wheel; and
a spring biasing the inner bearing portion and the outer bearing portion toward the face plate.

10. The input device of claim 9, wherein the housing comprises:
an inner notch that receives the inner bearing portion for rotation; and
an outer notch that receives the outer bearing portion for rotation.

11. The input device of claim 10, wherein the spring biases the inner bearing portion against the inner notch and biases the outer bearing portion against the outer notch.

12. The input device of claim 9, wherein the spring comprises:
an inner biasing arm contacting the inner bearing portion; and
an outer biasing arm contacting the outer bearing portion.

13. The input device of claim 12, wherein the spring comprises:
an inner preload arm biased against an inner preload surface of the housing; and
an outer preload arm biased against an outer preload surface of the housing, wherein the inner preload arm biases the inner biasing arm against the inner bearing portion, and the outer preload arm biases the outer biasing arm against the outer bearing portion.

14. The input device of claim 12, wherein the spring comprises a transverse arm extending between the inner biasing arm and the outer biasing arm.

15. The input device of claim 14, wherein the transverse arm comprises a trigger feature configured to depress a switch when the scroll wheel is translated away from the face plate.

16. The input device of claim 9, wherein the spring is a wire form.

17. An input device comprising:
a housing comprising a face plate that defines a left aperture and a right aperture;
a left scroll wheel assembly comprising:
a left scroll wheel protruding from the left aperture;
a left rotary encoder;
a left shaft coupling the left scroll wheel to the left rotary encoder, the left shaft comprising a left inner bearing portion located on an inner end of the left scroll wheel and a left outer bearing portion located on an outer end of the left scroll wheel; and
a left spring biasing the left inner bearing portion and the left outer bearing portion toward the face plate; and
a right scroll wheel assembly comprising:
a right scroll wheel protruding from the right aperture;
a right rotary encoder;
a right shaft coupling the right scroll wheel to the right rotary encoder, the right shaft comprising a right inner bearing portion located on an inner end of the right scroll wheel and a right outer bearing portion located on an outer end of the right scroll wheel; and
a right spring biasing the right inner bearing portion and the right outer bearing portion toward the face plate.

18. The input device of claim 17, wherein the left spring biases the left inner bearing portion against a left inner notch of the housing and biases the left outer bearing portion against a left outer notch of the housing, and the right spring biases the right inner bearing portion against a right inner notch of the housing and biases the right outer bearing portion against a right outer notch of the housing.

19. The input device of claim 17, wherein:
the left spring comprises a left inner biasing arm contacting the left inner bearing portion of the left shaft, and a left outer biasing arm contacting the left outer bearing portion of the left shaft; and
the right spring comprises a right inner biasing arm contacting the right inner bearing portion of the right shaft and a right outer biasing arm contacting the right outer bearing portion of the right shaft.

20. The input device of claim 19, wherein the left spring comprises a left transverse arm extending between the left inner biasing arm and the left outer biasing arm, and the right spring comprises a right transverse arm extending between the right inner biasing arm and the right outer biasing arm.
